(19) United States
(12) Patent Application Publication
(10) Pub. No.: US 2010/0274606 A1
(43) Pub. Date: Oct. 28, 2010

(54) COMPUTER SYSTEM AND METHOD FOR SUPPORTING AN E-COMMERCE ENTERPRISE HAVING ONLINE E-FRANCHISES

(76) Inventors: Gerald S. Fain, Framingham, MA (US); Stephen M. Fain, Tamarac, FL (US); Richard E. Friedman, Springfield, MA (US); Lawrence R. Schultz, South Lancaster, MA (US); Joseph A. Shrand, Marshfield, MA (US)

Correspondence Address: CESARI AND MCKENNA, LLP, 88 BLACK FALCON AVENUE, BOSTON, MA, 02210, US

(21) Appl. No.: 12/475,915

(22) Filed: Jun. 1, 2009

Related U.S. Application Data
(60) Provisional application No. 61/172,501, filed on Apr. 24, 2009.

(51) Int. Cl. G06Q 30/00; G06Q 10/00; G06Q 20/00; G06Q 40/00

(52) U.S. Cl. 705/7; 705/26

(57) ABSTRACT

In one embodiment, a centralized website may be generated, stored, and executed on servers, where the centralized website has a particular “look and feel” (e.g., a template). In association with granting online e-franchise rights to a secondary entity, a secondary website may be generated, stored, and executed (e.g., on the servers) for the secondary entity and its particular field of endeavor, where each secondary website has the same particular look and feel as the centralized website. Stored content for the secondary website may be managed and monitored to ensure that it (in addition to the business practice of the secondary entity) is operated in accordance with standards set forth by the centralized entity. In this manner, novel e-commerce models may be created and operated, such as a virtual community of associated alliance members that may be accessed by outside users familiar with and confident in the community.

### CROSS REFERENCE TO RELATED APPLICATIONS

The present application claims the benefit of U.S. Provisional Patent Application Ser. No. 61/172,501, filed on Apr. 24, 2009 by Fain et al., for a COMPUTER SYSTEM AND METHOD FOR SUPPORTING AN E-COMMERCE ENTERPRISE HAVING ONLINE FRANCHISES, the contents of which are hereby incorporated by reference in its entirety.

### BACKGROUND OF THE INVENTION

1. Field of the Invention

The present invention relates generally to computer networks, and, more particularly, to computer networks that support e-commerce.

2. Background Information

Electronic commerce, commonly known as “e-commerce,” consists of buying products and/or services utilizing electronic systems such as the Internet and other computer networks. With the advancement of technology and the globalization of the ability to communicate over the Internet, the amount of trade conducted electronically has grown extraordinarily in recent years. E-commerce allows existing, traditional, as well as specifically created/designed entities that offer products/services to expand markets and reach individuals across the globe.

However, there still remain many individuals living in impoverished areas of the world who have products and services that may be of interest to consumers, yet these individuals may lack the resources and/or knowledge to engage in e-commerce. Also, certain individuals or entities may have the economic resources and knowledge to conduct e-commerce, though it may be difficult to succeed while competing with larger well-known e-commerce entities, such as Amazon.com, Ebay.com, etc. In addition, for consumers of global e-commerce, the reliability of whom they are interacting with may be especially important, specifically knowing whether the entity offering the product or service is a legitimate seller or a “scam artist” (particularly where the entity is located thousands of miles away in a remote village or area).

Therefore, there remains a need to provide legitimate entities/sellers (including multinational corporations alongside minimally capitalized emerging entrepreneurs) with an opportunity to engage in global e-commerce on a platform for offering their products and services (e.g., side-by-side). Moreover, there remains a need to provide consumers with confidence that the entity that they are buying a product/service from is legitimate, reliable, and abides by fair trade and financial transparency principles and practices.

### SUMMARY OF THE INVENTION

According to one or more embodiments of the present invention as described herein, a centralized entity (e.g., an organization, corporation etc.) may generate, store, and execute a centralized website on one or more servers, such that the centralized website has a particular “look and feel.” The centralized entity may then grant “online e-franchise rights” to a secondary entity (an “online e-franchisee”) for a particular field of endeavor within the centralized website, where the online e-franchise rights grant the secondary entity rights (e.g., sole rights) to operate within the particular field of endeavor for the centralized website. A secondary website may then be generated, stored, and executed (e.g., by the centralized entity on the server) for the secondary entity and the particular field of endeavor that has the same particular look and feel as the centralized website. Content stored on the server for the secondary website may be managed by the secondary entity, and the secondary website (e.g., the content, its operation, its financial transactions, etc.) may be monitored to ensure that it is being operated in accordance with standards set forth by the centralized entity.

Various aspects of the present invention are directed to particular implementation details, from the perspective of the various parties in relation to the underlying computer architecture. For example, the novel computer architecture and functionality may be used to create a virtual community of alliance members, where outside users may access the virtual community (e.g., through the Internet). These outside users may then feel secure that each alliance member (e.g., and their associated website on the community) is being held to the same standards as the rest of the virtual community, in addition to the outside users having an intrinsic comfort with each individual website since they all have the same look and feel of the particular virtual community. Further, the computer architecture may be “brought” to the secondary users (online franchisees) to spread the global reach of the virtual community to regions not previously or conventionally accustomed to e-commerce business or transactions. Therefore, the computer architecture described in accordance with the present invention provides a foundation for creating and operating novel e-commerce models.

Advantageously, then, in addition to the functionality afforded by the computer architecture itself, the present invention provides entities/sellers with the opportunity to engage in e-commerce where they can receive and/or operate a platform for offering their products and services online. Further, the present invention provides consumers with confidence that the online entity that they are buying a product/service from is legitimate and reliable.

### BRIEF DESCRIPTION OF THE DRAWINGS

The advantages of the invention may be better understood by referring to the following description in conjunction with the accompanying drawings in which like reference numerals indicate identically or functionally similar elements, of which:

FIG. 1 is a schematic diagram illustrating a simplified view of global communication and global e-commerce;

FIG. 2 is a schematic block diagram representing an example computer architecture configuration of the present invention;

FIG. 3 is a schematic block diagram of an example server that may be advantageously used with one or more embodiments described herein;

FIG. 4 is a schematic block diagram of the example server illustratively represented as a logical arrangement of one or more functioning and inter-collaborative components;

FIG. 5 is a flowchart of an example procedure for use with online e-franchise rights for a secondary entity's secondary website on a centralized website according to one or more embodiments of the present invention;

FIGS. 6A and 6B are flowcharts of example procedures for distributing and/or receiving online e-franchise rights;

FIG. 7 is a flowchart of an example procedure for consumer or user interaction with the centralized and secondary websites; and

FIG. 8 is a schematic block diagram of an example relationship between the centralized website/entity and the secondary websites/entities.

### DETAILED DESCRIPTION OF AN ILLUSTRATIVE EMBODIMENT

### I. Computer Architecture and Functionality

As noted above, e-commerce consists of buying products and/or services over computer networks. While many people in today's society have access to e-commerce technologies (buying and/or selling), there are still many individuals who do not have such access. By supplying these individuals with the means to perform e-commerce, the true breadth of e-commerce may be expanded globally. For example, people living in impoverished areas of the world may be able to sell their unique products and services to other people all around the world (e.g., to more developed countries), and may also be able to receive products and services in return.

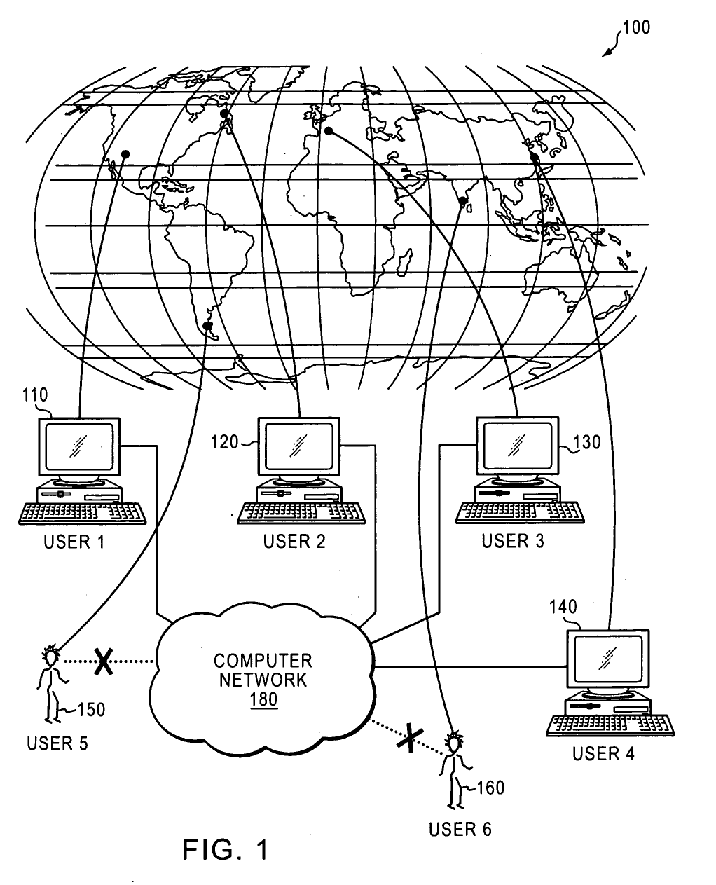

FIG. 1 is a schematic diagram illustrating a simplified view 100 of the current state of global communication and global e-commerce, and certain problems associated therewith. Specifically, as is known in the art, the Internet provides a way in which users (e.g., 110, 120, 130, 140, etc.) can communicate amongst one another despite the fact that they may be separated by great distances. For example, a user 120 in Canada may communicate with a user 140 in China via network 180. However, there are still many individuals, such as individuals 150 and 160 of FIG. 1, who are unable to engage in this type of activity. For instance, users 150 and 160 may lack the financial capabilities and/or knowledge to engage in this type of e-commerce. Particularly, users 150 and 160 may not own electronic devices with Internet access capabilities, or may not understand how the Internet works since many of these individuals may live in impoverished conditions.

In addition, as also mentioned above, there may be individuals who do have the requisite capabilities and knowledge to participate in e-commerce, but are discouraged from doing so because they believe they cannot succeed while competing with well-established global e-commerce entities (e.g., Amazon.com, etc.). For instance, these individuals may have a small niche product to sell, or may feel they do not have enough training or exposure to properly market their product successfully. Also, the fact that consumers of global e-commerce demand reliability of an e-commerce business (for instance, checking user ratings and comments on a seller prior to purchasing a product) may create a difficult barrier for certain start-up e-commerce entities. Specifically, it is important to know whether an e-commerce entity is a legitimate (e.g., validated) seller or a “scam artist” (particularly where the entity is located thousands of miles away in a remote village or area).

The present invention thus provides entities/sellers with the opportunity to engage in e-commerce where they can receive a platform for offering their products and services, and also provides consumers with confidence that the entity that they are buying a product/service from is legitimate and reliable (such as through standards and principles to which the entities need to adhere). In particular, the present invention is directed to providing technology for e-commerce, while incorporating numerous advantageous features such as sophisticated social networking technology, search engine optimization (SEO), and microeconomics as described in detail herein.

Specifically, according to one or more embodiments of the present invention as described in further detail herein, the illustrative computer architecture comprises hardware and software configured in a manner to allow a centralized entity (e.g., an organization, corporation etc.) to generate, store, and execute a centralized website with a particular “look and feel.” Any interested e-commerce providers (sellers) may then associate themselves with the centralized entity (e.g., with a centralized website of the centralized entity) by acquiring “online e-franchise rights” for their e-commerce field of endeavor, and managing a secondary website which may be stored and executed by the centralized entity and that has the same particular look and feel as the centralized website (described in more detail below). In this manner, e-commerce consumers (buyers, online visitors, etc.) may feel secure that each website associated with the centralized entity is held to the standards of the centralized entity, and these consumers are comfortable with the websites since they all have the same look and feel as each other (and as the centralized entity's website). Further, the computer architecture may be “brought” to the secondary users (online e-franchisees) to spread the global reach of e-commerce to regions not previously or conventionally accustomed to e-commerce business or transactions. Therefore, the computer architecture described in accordance with the present invention provides the foundation for novel e-commerce models to be created and operated.

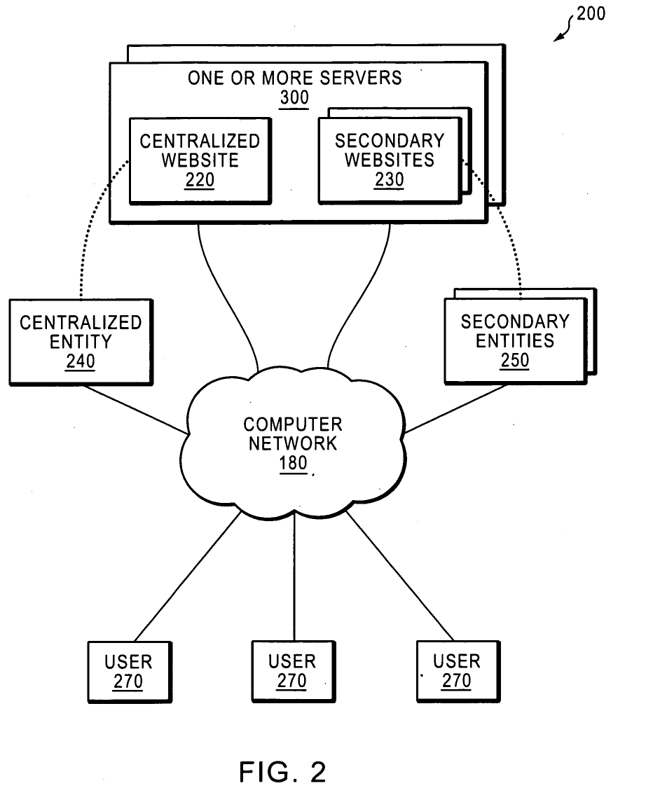

FIG. 2 is a schematic block diagram representing an example computer architecture configuration 200 of the present invention (the components and behavior of which are discussed in detail further below). Specifically, one or more servers 300 may be configured to support a centralized website 220 (e.g., for the centralized entity 240) and one or more secondary websites 230 (e.g., for the secondary entities 250). For instance, as described below, centralized entity 240 may control and maintain the centralized website 220 with a particular look and feel, as well as operational standards and policies, while a particular secondary entity 250 controls and maintains a particular secondary website 230 in accordance with those standards/policies and having the same look and feel. Note that the centralized website and secondary website may, though need not, be stored on the same servers. Alternatively, the servers may be globally distributed, such that a particular server may be assigned to a secondary entity/website, e.g., based on a location of the secondary entity (or other reasons understood by those skilled in the art). Interaction between the centralized website, secondary websites, and users (e.g., consumers) 270 may be achieved through the use of network 180, such as the Internet or other conventional telecommunications technologies.

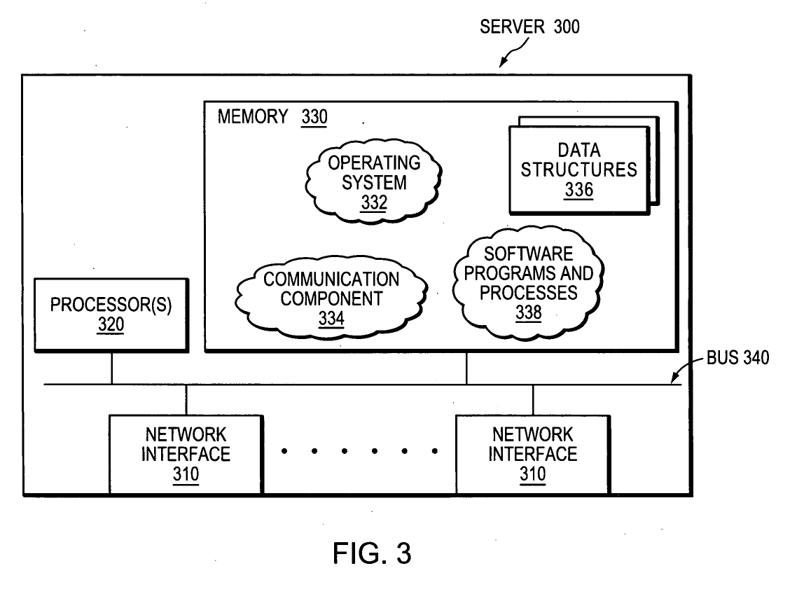

Particularly, FIG. 3 is a schematic block diagram of an example server 300 that may be advantageously used with one or more embodiments described herein, the functionality of which is also described in more detail below. The server, which may be embodied as a plurality of servers, one or more host computers, etc., may include a plurality of network interfaces 310, one or more processors 320, and a memory 330 interconnected by a system bus 340. The network interfaces 310 contain the mechanical, electrical, and signaling circuitry for communicating data over physical links coupled to the network 180. For instance, the network interfaces may be configured to transmit and/or receive data using a variety of different communication protocols, e.g., conventional Internet and various website protocols, as will be understood by those skilled in the art.

The memory 330 of the illustrative server 300 comprises a plurality of storage locations that are addressable by the processor(s) 320 and the network interfaces 310 for storing software programs and data structures 336 associated with the embodiments described herein. The processor(s) 320 may comprise necessary elements or logic adapted to execute the software programs or processes 338 and manipulate the data structures 336. An operating system 332, portions of which are typically resident in memory 330 and executed by the processor(s), functionally organizes the server, by inter alia, invoking operations in support of software processes and/or services executing on the server. A communication component 334 is executed by the processor(s) and allows components with the system to communicate (e.g., users, entities, administrators, etc.). It will be apparent to those skilled that other types of processors and memory, including various computer-readable media, may be used to store and execute program instructions pertaining to the inventive techniques described herein.

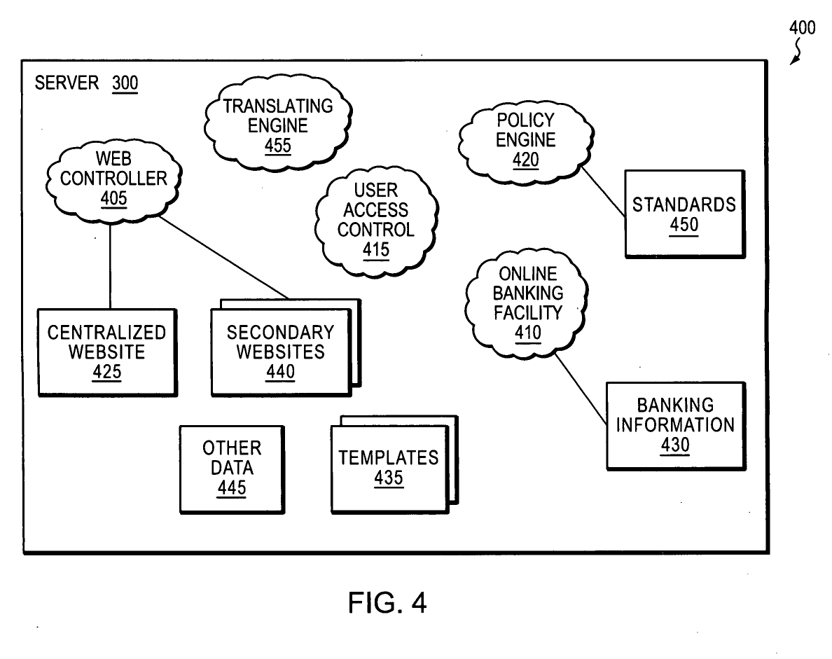

As shown in FIG. 4, an alternative view 400 of the one or more servers 300 of FIG. 3 may be illustratively represented as a logical arrangement of one or more functioning and inter-collaborative components. For instance, a logical arrangement of server 300 may specifically demonstrate that software processes 338 and data structures 336 may be composed of a website controller 405, an online banking facility 410, an user access control process 415, a policy engine 420, a centralized website 425, banking information 430, templates 435, one or more secondary websites 440, other data 445, standards 450, and translating engine 455, the functionality and operative behavior of each which will be described in detail herein.

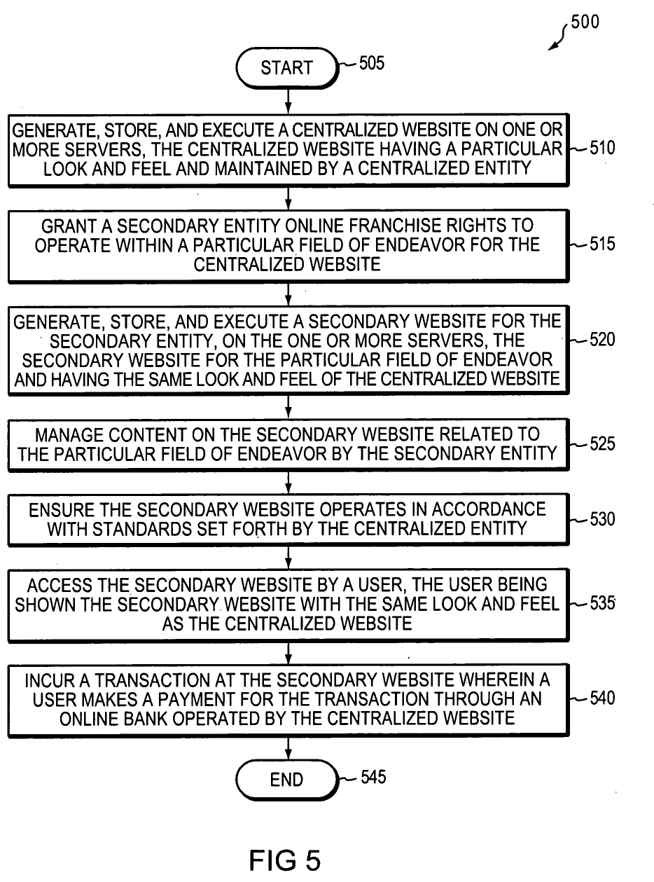

Generally, each of the processes/services 338 of the server 300 (e.g., 405, 410, 415, and 420) may contain computer executable instructions executed by a processor 320 to perform functions related to their respective operations, e.g., as understood by those skilled in the art where applicable, and as further described herein otherwise. For instance, online banking facility (process) 410 may be executed to perform the banking techniques described herein, as well as conventional banking techniques not specifically addressed herein. Illustratively, the techniques described herein may therefore be performed by hardware, software, and/or firmware, such as in accordance with the operation of the processes and/or services 338, which may both manage and operate based on the data structures 336 (e.g., 425, 430, 435, 440, 445, and 450) as described in detail with reference to FIGS. 5-7 below.

Operationally, FIG. 5 demonstrates a technique that may be performed using the computer architecture above in accordance with the present invention, e.g., for use with online e-franchise rights of a secondary entity. The procedure 500 begins in step 505, and continues to step 510, where a centralized entity 240 (or a representative of the centralized entity) may generate a corresponding centralized website 220 which may be stored and executed on one or more servers 300 (e.g., executed by website controller 405). Illustratively, the centralized entity may be a company, organization, individual, group of individuals, committee, etc. that is tasked with organizing and overseeing the computer architecture herein. Servers 300 may be locally connected to the centralized entity (e.g., within a premises of the centralized entity) or remotely located at a different off-site location (e.g., leased server space from a service provider). The centralized website itself may be generated using any appropriate programming language, such as HTML or other languages well-known to those skilled in the art. Note that the creation of and any modifications to the centralized website may be performed by the centralized entity (or representative) directly, or by a service provider at the request of the centralized entity.

Particularly, the content, format, and structure of the centralized website 220 may be designed by the centralized entity, and according to the present invention, may be designed purposely with a particular “look and feel.” Specifically, the look and feel of the centralized website may correspond to selected colors, logos, fonts, layout (e.g., locations where text and hyperlinks are placed on the website), etc., and may, though need not, include various recognizable images, trademarks, or service marks of the centralized entity. In this manner, the look and feel of the centralized website advantageously provides the centralized website with “brand name recognition,” where users/clients that access the centralized website may eventually recognize the look and feel of the centralized website, and generally associate it with the centralized entity. Notably, certain aspects of the look and feel of the centralized website 220 may be used to devise templates 435, which are, for example, created separately from the centralized website yet having the centralized website's look and feel.

According to the illustrative technique described herein, a secondary entity 230 may obtain (be granted) online e-franchise rights (in step 515) to operate within a particular field of endeavor for the centralized website 220. For example, online e-franchise rights (which may be sole rights, or shared rights) allow the secondary entity to use the centralized website (and reputation of the centralized entity) as a platform to develop a business, for instance, in the particular field of endeavor/interest. For example, an individual living in California may wish to obtain e-franchise rights to operate a business in the field of “surfing” utilizing the platform of the centralized website. (Note that in some instances, the field of endeavor does not have to be a business, but can simply be an area of interest to the secondary entity.)

Sole online e-franchise rights may be granted to the surfing online e-franchisee (secondary entity), thus indicating that no other entity (e.g., individual or enterprise) can operate a business in the field of surfing utilizing the platform of the centralized website. Illustratively, the centralized website 220/425 may be designed such that portions of the website may be delineated for particular geographic regions and/or particular languages. For example, a user accessing the centralized website may navigate the centralized website to select “surfing: in California” (or “California activities: surfing,” etc.). Thus, sole online e-franchise rights may imply sole rights that restricted to a certain geographical area (e.g., a state, a region, a country, etc.). For example, the secondary entity in the example above may have the sole e-franchise rights in the state of California. In this case, a different entity, in say Australia, could obtain sole online e-franchise rights for surfing in Australia (e.g., “surfing: in Australia” (or “Australia activities: surfing,” etc.). Note that the users accessing the centralized website are not limited to their searched locations, such that a California user may wish to research surfing in Australia, and vice versa.

The secondary entity (online e-franchisee) may obtain the e-franchise rights in a variety of ways. For example, the secondary entity may purchase the e-franchise rights from the centralized entity for a price set by the centralized entity. In another example, the secondary entity may sell an “interest” in his/her potential business by selling (or giving) shares of the potential business' stock to the centralized entity. In this situation the centralized entity has a direct interest in the success of the secondary entity.

Note that in certain instances the secondary entity may secure “seed money” from an outside source (e.g., a third entity) to obtain the online e-franchise rights. A contract may be developed between the secondary and third entity that may state, for example, that the third entity will provide the secondary entity with the income to obtain the online e-franchise rights while the secondary entity will provide the third entity with future compensation. Accordingly, in certain situations, this contract may need to be approved by the centralized website, to ensure that there is a “meeting of the minds” and that the contract is legitimate and reasonable. For example, if the secondary entity is an individual living in California who does not have the funds to obtain the online e-franchise rights, he/she may search out “investors” or affluent individuals who will “front” him/her the money so that he/she can establish the business using the centralized website platform. In exchange, the secondary entity may agree to give the investor shares of stock in the business, or a percentage of the profits received, etc.

Once the secondary entity 250 has obtained the online e-franchise rights, a secondary website 230/440 may be generated, stored, and executed (in step 520) on the one or more servers 300, e.g., controlled by the centralized entity. The secondary website 440 may be used by the secondary entity to provide online content for the particular field of endeavor for which the online e-franchise rights were secured (e.g., California surfing in the example above). According to the present invention, the secondary website may be generated with the same look and feel as that of the centralized website. That is, specifically, the centralized website 425 and the secondary website 440 may share the same logos, color scheme, font choices, layout, trademarks, service marks, etc. In this manner, user/clients may readily associate the secondary website with the centralized website/entity, thus beneficially providing consumers with confidence that the secondary entity, who may be an unknown individual (e.g., a surf enthusiast in California), is affiliated with the larger and likely more well-known centralized entity having “brand name recognition.” Thus, the consumers (users/clients of the centralized and secondary websites) may be more likely to conduct business and interact with the secondary entity through the secondary website.

In addition, the secondary website 440 may be created based on the defined templates 435 from above, such that each secondary website associated/affiliated with the centralized website not only has the same look and feel, but also may be designed to have the same type of content in the same general location. For instance, the template 435 may contain a layout for each secondary website that indicates a location for information regarding products that may be purchased (e.g., online shopping for surfboards), information (e.g., a history of the field of endeavor, e.g., history of surfing), events (e.g., surf competitions in California), travel information (weather, recommended hotels, etc.), contact information for the secondary entity, and so on. As such, as a supplement to the consumer's comfort with the look and feel of the centralized website at the secondary website, a consumer may also be able to easily navigate the secondary website in a manner dictated by the centralized entity, and in a manner that through familiarity with navigating other secondary websites of the centralized website becomes natural to a regular consumer of the centralized website.

In step 525, the secondary entity may manage the content related to the particular field of endeavor on the secondary website (as stored on the server 300). The content may include a variety of things, such as information, products for purchase, etc. For example, if the particular field of endeavor is surfing as described above, the content may include the sale of surf boards, the sale of surfer clothing and accessories, hyperlinks to websites that inform individuals about oceanic activity such as wave height and behavior, hyperlinks to vacation destinations that have recommended surfing activities, etc. The information that can be stored on the secondary website is limitless. In particular, the templates 435 may be used to guide (or demand) the secondary entity to include useful information pertinent to running a business in accordance with standards and principles set forth by the centralized entity. That is, similar to conventional franchising, because an online e-franchisee is associated with the franchiser (the centralized entity), that franchiser may request/demand that the secondary websites be operated in a manner consistent with its franchising principles. As such, consumers accessing the secondary website (step 535) are shown the same look and feel as the centralized website, and may ascertain information and purchase products that they deem of interest in essentially the same manner regardless of which secondary website they are currently visiting. As explained above, the consumer may have confidence in the legitimacy and trustworthiness of the secondary website because the secondary website has the same look and feel as the centralized website that the consumer may know as a reliable global corporation. At the same time (and possibly as a cause of the centralized entity's reliability), the consumer may generally be afforded the same type of information/content at each secondary website due to the standard use of the shared templates 435.

As the secondary website is managed and utilized by the secondary entity (e.g., accessed by visitors and consumers), at step 530 the centralized entity may monitor the activity and content on the secondary website to ensure that the secondary website is adhering to the standards and regulations set forth by the centralized entity. Illustratively, the standards and regulation may, though need not, relate to fair business practice. For example, if the secondary website was advertising that the surf boards being sold are made of polyurethane but are in fact being made from a cheaper substitute, the centralized website may revoke the secondary entity's online e-franchise rights, or may penalize the secondary entity for violating the standards and regulations. As another example, consider a situation where a secondary entity is selling a product that is vastly overpriced. The centralized entity may deem that this sort of behavior as inappropriate and may revoke the secondary entity's online e-franchise rights or may penalize the secondary entity in some manner set forth by the centralized entity. Other standards may include “inappropriate content” or “offensive content” defined by the centralized entity. Accordingly, the set of standards 450 may be a textual representation of standards to be read and managed by the individuals responsible, or may be a computer-implemented set of policies (e.g., via policy engine 420), which may define and manage certain blocked terms or phrases, monitor and/or control access to the websites (e.g., third-party linking to/from the secondary websites), etc. The policies and standards defined may be essentially any rule that is enforceable, and may be applied to any of the secondary entity's conduct, the secondary website's content/functionality, and the client/consumer's use of the website. (The examples herein are merely representative examples, and are not meant to limit the scope of the present invention.)

In addition, during access of the website in step 535, at step 540 (e.g., an extended portion of step 535), users may conduct a business transaction while accessing the secondary website. In particular, the user/consumer may exchange money for a product/service being offered by the secondary entity. In this situation, an online banking facility 410 operated by the centralized entity 240 may be used. (The occurrence of a transaction and function of the online banking facility is discussed in further detail below.) In one embodiment of the present invention, transactions through the centralized website any secondary websites are required to use the online banking facility, however other embodiments may utilize any other means of exchanging money known to those skilled in the art. (Utilizing a centralized banking facility may provide benefits, such as further control of the secondary entity's conduct per the principles and standards, as well as other, e.g., financial, benefits.) The procedure 500 ends in step 545, notably with the ability of each step being revisited in any particular order at nearly any time (e.g., editing and creating content, accessing the websites, granting rights, etc.).

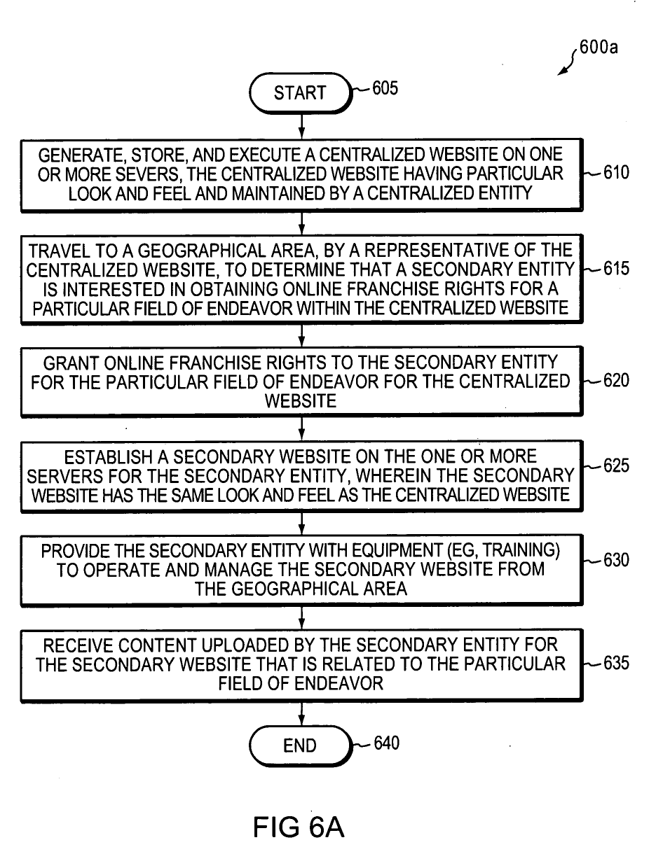

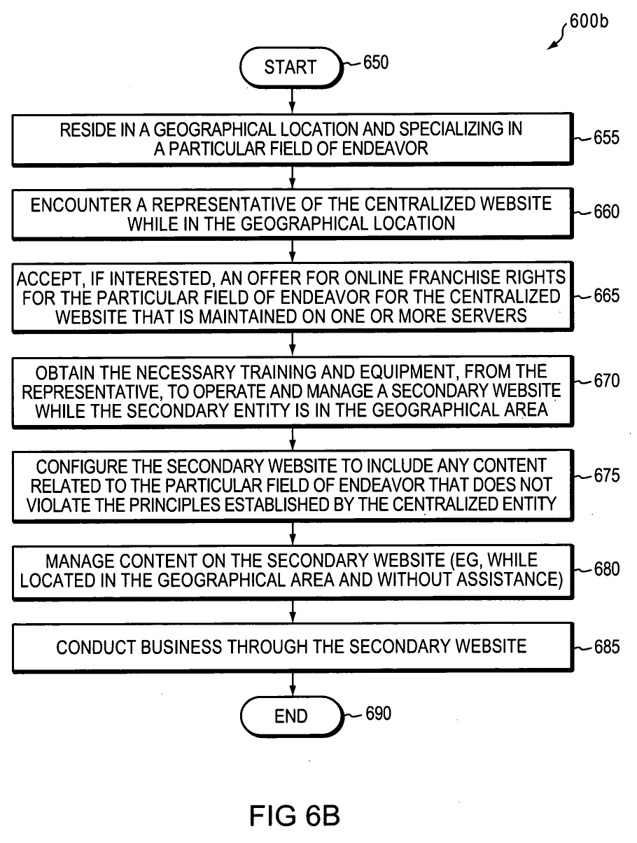

According to an aspect of the present invention, the name brand recognition of the centralized entity 240 need not be “sought after” by individual business owners (or start-ups), but may instead be propagated by the centralized entity itself to spread its business outreach across the globe. For instance, FIG. 6A demonstrates an example technique for broadening the online reach of the centralized entity's secondary website affiliates, where a representative of the centralized entity encounters individuals interested in obtaining online e-franchise rights within the centralized website. The example procedure 600a starts in step 605, where in step 610 the centralized website 425 is established, as described above. The procedure continues then to step 615, where the representative of the centralized entity may travel to a particular geographical area. For example, the representative may travel to Mumbai, India or other country, either for the purpose of spreading propaganda for the centralized entity, or simply for the sake of travel (or other purpose not specifically related to the centralized entity). During the representative's travels, he/she may encounter an individual (e.g., a potential secondary entity) who is selling unique hand made baskets. As may often be the case in many parts of the world, this individual may be impoverished and may not have access to a computer, or for that matter, may not even know what a computer is.

In this instance, the representative may explain that by utilizing the online platform offered by the centralized website, the secondary entity may potentially offer/market his baskets (i.e., product) to a vast amount of individuals and entities, far more than the number of people he would reach on the side of the road in Mumbai. This in turn could lead to greater monetary success for the individual, spreading the global economy and the products offered through the centralized website (that is, through secondary websites associated with the centralized website). The representative may explain the notion of “brand name recognition” and may also explain how offering his/her product “online” would in fact reach more consumers. If this notion is appealing to the secondary entity, the secondary entity may agree to obtain online e-franchise rights from the centralized entity for that particular field of endeavor, e.g., of “basket making,” as shown in step 620. As mentioned above, the online e-franchise rights may be for a particular geographical area (e.g., India, Mumbai, a town within Mumbai) or for the entire centralized website as a whole (e.g., the only basket weaving/making entity of the centralized website). The individual (secondary entity) may obtain the online e-franchise rights for money, at a price set by the centralized entity or through other means as expressed above. In this example, where the individual in Mumbai may be impoverished, “seed money” may be received from an outside source (which may, in fact, be the centralized entity), or may grant stocks in the potential (e.g., basket making) business to the centralized entity.

At step 625, a corresponding secondary website 440 may then be generated and stored on the one or more servers 300 having the same look and feel as that of the centralized website, in a manner as described above. In particular, since as discussed above, the same look and feel can provide consumers with the confidence to engage in transactions with unknown secondary entities. For example, a consumer in Los Angeles may be reluctant to buy a basket online from an individual in Mumbai that he does not know. However, because the secondary website of the Mumbai basket maker is affiliated with the centralized entity, the consumer may feel more comfortable in engaging in transactions with the secondary entity knowing that the centralized entity is in some form “vouching” for the secondary entity. For example, the affiliation may be depicted not only through web-based linking and domain names (e.g., a link from the centralized website to the secondary website, or a domain name, such as “www.centralized-enity's-website.com/secondary-entity's-website.html,” merely an example), but also visually through the same look and feel as described in detail above.

At step 630, if necessary, the representative may also provide the secondary entity with necessary equipment to manage the secondary website for the particular field of endeavor (e.g., basket making), so that the secondary entity will be able to manage/run the secondary website from the geographical area of Mumbai without outside assistance. Such equipment may be a computer with Internet access, accounting programs, or other software that may be helpful in running a business. Other equipment related to the sustainability and success of the secondary website may also be provided by the representative (e.g., digital cameras, phones, etc., even shipping materials). Also, appropriate training to manage/run the secondary website, for instance, something as simple as how to utilize the Internet, or something as complicated as uploading information on the website or keeping track of your profit margin. (Any training related to the sustainability and success of the secondary website, and these examples are merely illustrative.)

Accordingly, the secondary entity may then begin successfully uploading content to the secondary website that is related to the particular field of endeavor in step 635. For example, the secondary entity may sell baskets made from different materials, of different sizes and prices from the secondary website. Further, the secondary entity may provide hyperlinks to websites related to basket weaving that he/she has come to learn about. Thus, the secondary entity may upload limitless amounts of information related to the particular field of endeavor (e.g., based on the templates 435), as long as it does not violate the standards and regulations set forth by the centralized entity.

The procedure 600a ends in step 640, having expanded the reach of the centralized websites online e-franchise. As a further example, suppose that the representative of the centralized entity encounters a third entity in Mumbai, a lady selling colorful Indian saris. The representative would interact with the third entity in a similar manner in which the representative interacted with the second entity in procedure 600a. Specifically, the third entity may obtain online e-franchise rights for saris, where the sari secondary website would have the same look and feel as that of the centralized website and the basket making secondary website. As described above, the same look and feel may provide consumers with the confidence to engage in online transactions with individuals they do not know, since those individuals (secondary entities) are associated with the known centralized website/entity.

Operationally, FIG. 6B is similar to that of FIG. 6A in that it discloses the manner in which a secondary entity may obtain online e-franchise rights from a representative of the centralized entity. However, FIG. 6B is illustratively shown from the perspective of the secondary entity. Specifically, procedure 600b begins at step 650, and continues to step 655 where the secondary entity resides in a particular geographical area and specializes in a particular field of endeavor (e.g., the basket maker/weaver in Mumbai). The secondary entity may (though need not be) generally unaware of the existence of the centralized entity or the centralized website. At step 660, the secondary entity is encountered by a representative of the centralized entity, where the representative informs the secondary entity about the opportunity to obtain online e-franchise rights within the centralized website. If interested, in step 665 the secondary entity may obtain the online e-franchise rights, and if necessary, may obtain in step 670 the necessary training and equipment from the representative to operate and manage the secondary website. At step 675, the secondary entity can configure the secondary website to include any data and information related to the particular field of endeavor (as long as the data and information do not violate the standards and regulations as set forth by the centralized entity), and at step 680, the secondary entity manages the secondary website from the geographical location, without outside assistance, thus operating (conducting) an online business that is a part of a centralized website/entity (i.e., as an online e-franchisee of Mumbai basket making, reachable from anywhere and anyone with Internet access) through the secondary website in step 685. The procedure 600b ends in step 690.

Notably, as an additional expansion to this example, any secondary website may offer travel related information particular to the e-franchised field of endeavor, and in addition, secondary websites may be specifically geared toward travel. For example, travel related secondary websites (or portions of other directed secondary websites) may include information such as site-seeing locations, what hotels and restaurants are recommended, local taxi rates, etc. Also, the secondary entity/franchisee may offer his/her own services, such as being a tour guide for individuals who decide to visit their particular region, or to show the consumers a particular trade, e.g., how to make the baskets if the consumer decides to travel to Mumbai. The consumers may thus obtain travel information or purchase travel related products and packages (e.g., hotel accommodations, travel guides, etc.) through the secondary website.

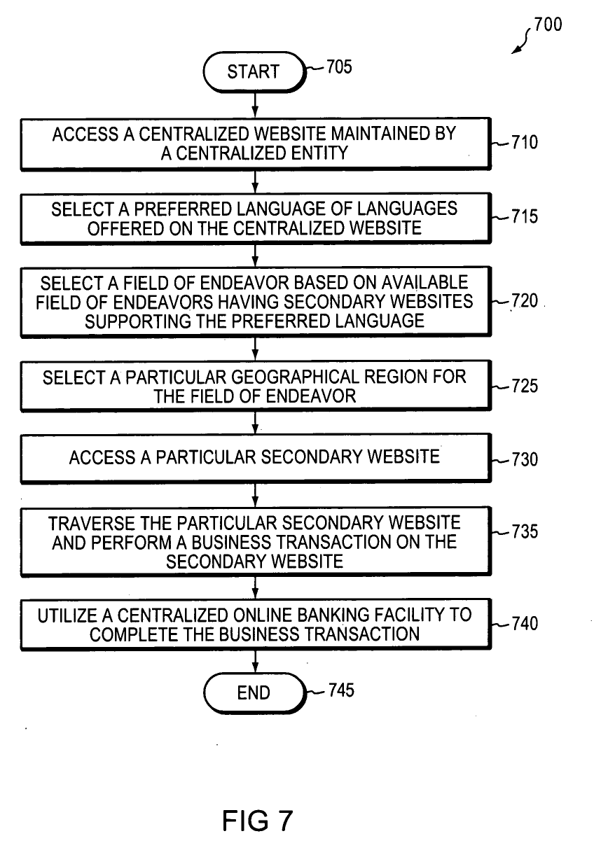

As an additional perspective of the embodiments of the present invention, FIG. 7 demonstrates an illustrative manner in which a consumer or user may interact with the centralized and secondary websites. In particular, procedure 700 begins at step 705, and continues to step 710 where the consumer accesses the centralized website that is maintained by the centralized entity, such as through the use of a computer, or electronic device that has access to the Internet. The consumer may access the centralized website with a particular purpose (e.g., purchasing a specific item, leaning about a particular topic, traveling to a particular location) or may access the centralized website to merely “browse” what the centralized website has to offer.

At step 715, the consumer entity may select a preferred language of a plurality of languages offered by the centralized website (e.g., official languages supported by the United Nations), which then directs the consumer to a version of the centralized website in that language, e.g., offering certain secondary websites that are available in that language. (Notably, translations of the centralized website and any secondary websites may be performed, e.g., by translating engine 455, to offer any website in any language. Alternatively, each supported language may have its own independently operated secondary websites, such that an English website for surfing may have a different secondary entity and different content than a Spanish website for surfing, etc.) In particular, the centralized website is intended to be global and allow consumers and individuals from all over the world that speak a variety of languages to visit the centralized website. For example, a user in the Middle East (e.g., Dubai) may access the centralized website and select Arabic as the preferred language. As such, the centralized website may be conveyed or displayed to the user in the Arabic language, and options (e.g., secondary websites) that are also available in Arabic are displayed to the consumer, accordingly.

At step 720, the consumer may then select a particular field of endeavor from the centralized website that is available in the selected language. (Note that the reverse is equally plausible, where the field of endeavor is chosen first, and then a list of available languages that have secondary websites for the field of endeavor may be presented to the consumer for selection). The particular field of endeavor may be surfing, saris, baskets, as described above, or essentially anything, such as the medical field, travel, chess, cooking, pets, education, etc. The different fields of endeavor that can be offered through the centralized website by online e-franchisees' secondary websites are limited only by the imaginations of the e-franchisees. Also, in step 725, in certain embodiments, the consumer may be directed to select a particular geographic region to which the online search should be directed. (Again, the order of selection may be any logical arrangement, such as selecting a language, then geographic region, then field of endeavor, or field of endeavor, then language, then geographic region, etc.)

In this example, assume that Arabic consumer would like to learn more about surfing. The consumer may select surfing as a field of endeavor (e.g., assuming there are any secondary websites that support surfing), and then a list of available regions having surfing secondary websites may be presented. For instance, perhaps a person speaking Arabic lives in California and loves to surf, and has obtained online e-franchise rights to and created an Arabic surfing secondary website for the state of California (which, as noted above, could be different and separate from online e-franchise rights and a secondary website for surfing in California that is in English, such as to avoid inherent difficulties in computerized translations between languages). The consumer may then be directed to access the secondary website (e.g., within an online domain of the centralized website) in step 730, and at step 735, may traverse the particular secondary website and may perform one or more business transactions. For example, the consumer may purchase a surfboard or surfing video that is being sold online by the secondary website. The consumer would have confidence that the secondary website is trustworthy and legitimate since the consumer accessed the secondary website through the centralized website and the look and feel of the secondary website is the same as the centralized website. In addition, the consumer may simply browse the secondary website, to observe what information the secondary website contains. For example, the secondary website may have hyperlinks (i.e., links that correspond to other websites) on the secondary website that are related to surfing. Further, the secondary website may include information related to making surfboards, surf competitions, etc. Again, the content that can be stored on the secondary website is essentially limitless, as long as the content does not compromise the standards and regulations set forth by the centralized entity. For instance, the Arabic consumer may wish to book travel to California to learn to surf, and the secondary entity (who assumedly speaks Arabic) could arrange to meet with the consumer to guide the consumer while surfing in California. The list of possibilities afforded by the underlying computer architecture of centralized and secondary websites is virtually endless.

Notably, in step 740, once the consumer makes a purchase form the secondary website, the consumer may be directed to utilize an online banking facility that is operated by the centralized entity. Specifically, the consumer may pay for the item being purchased through the online backing facility. The online banking facility, which is operated by the centralized entity, may then forward, a portion or the entire sum of money, to the secondary entity. The centralized online banking facility may thus provides the consumer with another level of confidence in knowing that the transaction is legitimate, and is not simply a means to “scam” money from an unsuspecting online user. The procedure 700 ends in step 745, such as when the consumer ends his/her online session with the secondary/centralized website.

The present invention as described herein is thus directed to the computer architecture and functionality that may be used to administrate a centralized website having a particular look and feel (e.g., a template), and one or more secondary websites that also have the same particular look and feel. In this manner, novel hardware and software arrangements are provided for use with novel online e-franchises, where entities/sellers are provided with the opportunity to engage in e-commerce where they can receive a platform for offering their products and services, while at the same time providing consumers with confidence that the entity that they are buying a product/service from is legitimate and reliable. This is vastly different from conventional franchises, in that conventional franchises are geographic only in nature. For example, one may acquire conventional franchise rights to fast food chain for a particular geographic location, having the same “look and feel” as the other fast food franchises. However, since the Internet is global, the conventional concept of geographic franchises no longer applies. Instead, the novel techniques above support the granting of online e-franchises for particular fields of endeavor within the centralized website, such that the online e-franchisees may be associated with the centralized website to receive the brand name recognition and legitimacy of the centralized entity, yet having a particular online market (e.g., sole rights on the centralized website to offer the related information and/or products, such as for a particular geographic region and/or language).

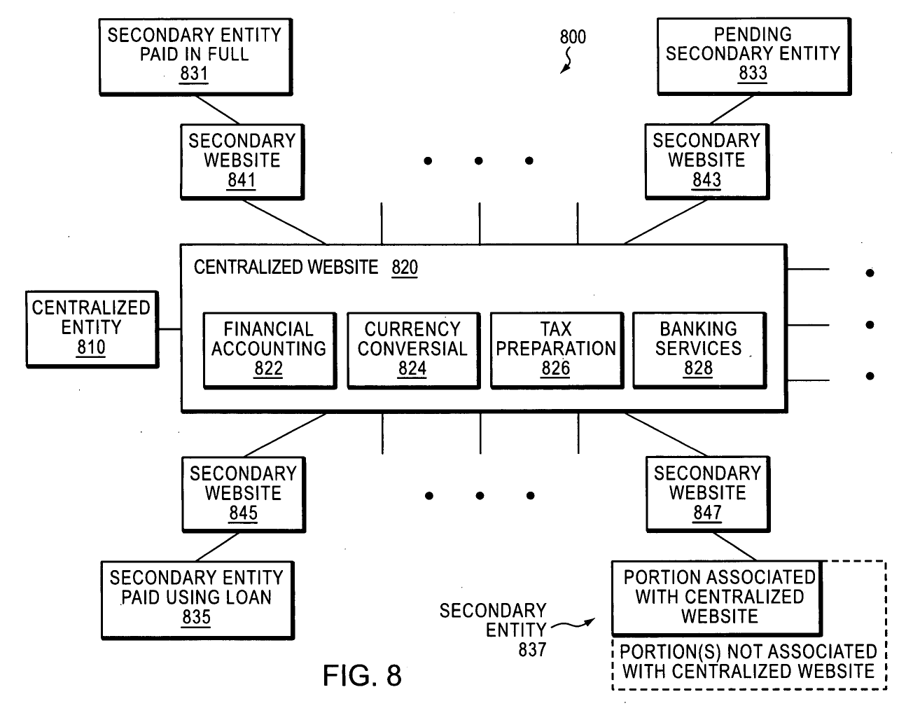

As one additional example, FIG. 8 illustrates the support a centralized entity 810 may provide, through a centralized website 820, to a plurality of secondary entities generally referred to as 830 (e.g., 831-837) managing the secondary websites generally referred to as 840 (e.g., 841-847, respectively). The centralized website may include features such as financial accounting 822, currency conversion 824, tax preparation 826, banking services 828, etc., for the plurality of secondary entities, each of which may be a “member” of the centralized website 820 with a different status. For instance, certain secondary entities 831 may have a membership paid in full, while pending secondary entities 833 may have not yet paid in full or are still undergoing membership approval. (For example, the underlying architecture supporting the centralized website may also include various security measures to dynamically ensure or to allow a human reviewer to ensure that the secondary entities have no prior history of unlawful business practices, such as through interconnections and database searches through various known criminal record depositories (e.g., FBI, Interpol, etc.)). Also, other secondary entities 835 may have paid using a loan, and there may be one or more secondary entities 837 with other entities outside of the centralized website (e.g., corporate entities).

The services of the centralized website are available to all members, for example, regardless of the type of secondary entity 830 or with certain restrictions based on membership status (e.g., pending, corporate, etc.). Financial accounting 822, for instance, may help the secondary entities/websites maintain such information as gross income, profits, overhead, and other accounting information related to the secondary website. Currency conversion 824 may provide end users and the secondary entities with the ability to determine the cost of products/services across countries and geographical boundaries where monetary units (and laws) may differ. Additionally, tax preparation 826 may provide each secondary entity, that may be operating in a different geographical area, with assistance in complying with the tax laws and procedures that are unique for that geographical area. Further, banking services 828, in general, may provide end users and the secondary entities with a uniform and centralized manner in which to conduct transactions. Moreover, the banking services may provide end users with transactional transparency (e.g., knowledge that the secondary entities is not being exploited and is in fact receiving proceeds from the transaction). For instance, transactional transparency may be afforded through video conferencing, such that a user may confirm that the secondary entity in fact made the product and/or received the money by visual interaction with the secondary entity via the online video conference.

In this manner, as shown in FIG. 8, the centralized website forms a logical center through which end users may access any number of related secondary websites, while providing the services of the centralized website to each secondary entity attached thereto. Accordingly, through use of the illustrative computer architecture and computer-implemented techniques described above, the online e-franchise model may be logically represented as the “star-like” or “hub-and-spoke” interrelations between the centralized entity and the secondary entities. End users accessing the system may navigate through the centralized website to reach the essentially limitless “spokes” of secondary websites, globally expanding the reach of e-commerce in a manner that exudes comfort and confidence to anyone involved.

### II. A Civil Society Organization

An Illustrative Use of One or More Embodiments Described Above

While the technology and techniques described above may be used by any business entity, “Human Potential Optimization” (HPO) is a phrase that defines the creative access or “mining” or prospecting for underdeveloped human talent, creativity, intelligence, virtue, and synergy intended to promote both independent financial security and civil societies worldwide. In particular, sophisticated electronic/digital technologies (communications, social networking, e-commerce, etc.), such as those described above, may be used as a means for accomplishing HPO.

For instance, prevailing economic theory and practice generally favor the position of limited resources and unlimited desire. That is, the value of goods and services is set by market conditions of supply and demand. HPO replaces a supply-and-demand theory that in certain circumstances is inherently impossible to sustain (e.g., oil reserves are finite and without adequate substitution may lead to the collapse of civilization) with a new paradigm of the marketplace; where human potential optimization is unlimited capital, thereby achieving the aims of economic and environmental sustainability making civil society in perpetuity a practical reality.

The centralized entity described above, therefore, may be embodied as a conventional profit-based company/organization, or may illustratively be an enterprise (profit, non-profit, not-for-profit, etc.) founded upon principles of fair-trade, transparency, and human potential optimization (HPO) as defined herein (one example may be adherence to the United Nations Universal Declaration of Human Rights). The illustrative centralized entity may be embodied as an e-commerce global corporate entity made up of independent “alliance” members (e.g., the online e-franchisees above), and having an overseeing organizational body (e.g., corporate leadership, board members, preferred stock holders, etc.). At the disposal of the centralized entity, are, among other things, the e-commerce, sophisticated social networking technology, search engine optimization (SEO), and microeconomics as described in detail above. In particular, the centralized entity/website itself may be comprised of a plurality of discrete but interrelated entities (e.g., web domains), such as the centralized bank, travel resources, learning resources, collaboration resources, contests and creative enterprise resources, etc.

The unique combination of principles and utilities described herein, in conjunction with trust and respect for human beings, may advantageously serve to define a civil society. Accordingly, the business conducted by the centralized entity may meet industry specific best practice standards for fair trade and financial transparency. Also, the use of the microeconomic development and venture capital enterprise aspects conceptualized herein may advance civil society in a capacity otherwise not conceived. That is, no other business model is as able to create and distribute wealth—without unfair leverage—simultaneously for both the rich and poor, and to simultaneously protect the exploitation of workers, protect the environment, advance what is best for the common-good, and optimize human potential globally.

To advance civil society, the illustrative centralized entity (hereinafter referred to as the “illustrative HPO entity” or “HPO entity”) is distinguished from conventional business entities by incorporating specific HPO principles (for example, where the unqualified acceptance of which may be conditions of membership of the entity, e.g., for the secondary entities). Specifically, individual membership by a secondary entity with the HPO entity may be established by acquisition of an online e-franchise enterprise or “alliance,” and is open to all citizens or legal entities of nations that promote civil society, for example, member states of the United Nations. That is, like the UN, the illustrative HPO entity may be dedicated to achieving world peace, humanitarian aims, and civil society goals, illustratively achieved by the microeconomic development and venture capital enterprise conceptualized herein.

As an example, members (secondary entities associated with) the illustrative HPO entity may be required to engage in fair trade practices (e.g., human rights), where financial transactions between two or more parities have a value placed on a particular product or service that is mutually determined, transparent, even-handed, equitable, and hallmarked by the integrity of arms-length bargaining as without favors, or hidden profit or damage in the social cost of production (e.g. environmental pollution, labor exploitation, etc.). In other words, all parties should be of equal bargaining position and agree to full disclosure, including all known direct or indirect costs or benefits. In addition, all members are permitted to engage in fair trade barter, in which all or part of a transaction may be subject to taxation by legal jurisdictions and/or any fees due to the centralized entity. Note that any instances of bartering or barter arrangements may be limited or otherwise defined in memoranda or specific contracts between parties to ensure protection of the parties and the overarching centralized entity.

Generally speaking, transparency is a necessary element of fair trade, where transparency is the antithesis of “hidden costs”. The criterion of transparency is met when the consumer is made aware of the real cost of goods and labor sufficiently in advance of the time of purchase. Real cost is calculated by adding labor, the amount paid by the creator or provider of the goods or services for raw materials, production, other reasonable costs for doing business and foreseeable social costs such as human or environmental damage. Labor is defined as the value of the worker, producer or provider as determined by fair trade. This conception of labor is intended to distinguish wage and hour practices as applied to organized labor from the value of human production (i.e., the value of a painting or bottle of wine, or hour of instruction learning to play chess is determined by the free-market, hence all goods and services are valued on independent merit as perceived by the seller and buyer).

Online E-Franchises-Alliances: Creation of a Civil Society

In addition to as described in detail above, an online e-franchise or “alliance” may be an e-franchise-like enterprise that represents a transparent, fair trading, and profit making secondary entity under corporate ownership of the illustrative HPO entity. The secondary entity may be an individual person or independent legally recognized business enterprise that agrees to abide by the civil society principles/standards set forth by the HPO entity, and failure to do so results in forfeiture of the rights of ownership. For instance, secondary entities may pay for the right to join the alliance of other secondary entities under the administration of the centralized HPO entity, pay fees to the HPO entity, and may pay legally imposed taxes and fees to their respective jurisdictions. The HPO entity and its alliance members (online e-franchisees) thus establish a virtual community comprised of members who are individual owners of the goods and services that they offer in the virtual marketplace utilizing fair trade practices. (Note that virtual communities are not autonomous political entities, and therefore may be required to ensure that all transactions comply with any and all applicable laws pertaining to them.)

Business opportunities that are present within the illustrative virtual community may comprise one or more of the following:
Showcasing: Showcasing is defined as bringing recognized and well-established products and services; and people with recognized and well-established gifts and talents to the virtual community (bringing well known members to the centralized HPO entity). In this arrangement, the member is likened to an agent that has secured the rights to manage, promote, and sell.
Mining: Mining is defined as bringing to the virtual community yet-to-be discovered products and services, and people with gifts and talents. In this arrangement, the member is likened to an agent that searches for and then secures the rights to manage, promote, and sell.
Seeding: Seeding (or prospecting) is defined as bringing to the virtual community promising but undeveloped products and services, as well as people with gifts and talents. In this arrangement, the member is likened to a teacher or mentor that searches for and then secures the rights to educate, refine, manage, promote, and sell. Seeding is especially important in addressing poverty as it intends to turn otherwise untapped human potential into for-profit business. For example, seeding might take the form of a “School for the Arts” (e.g., that abides by HPO entity principles) by teaching art to children while simultaneously providing basic education in literacy, mathematics, history, and science in addition to other subject areas.
Collaborating: Collaborating is defined as the synergetic use of the virtual community's resources. Here, the aim is to address civil society weaknesses by reducing the cost of doing business through more efficient use of resources, and/or filling gaps in needed services and product development. As a result, two virtual community members may come together as a single e-franchise (efficiency) or form a third enterprise (fill a gap). Collaborating is especially important in reducing waste, duplication, and unwarranted competition, thereby optimizing human potential.
Referral: Referral is defined as the no-cost obligation of virtual community members to demonstrate respect for the limits of their own expertise by turning away business that they are not qualified to provide and also respect for the expertise of other virtual community members by touting their expertise. Also, virtual community members may fulfill the civil society obligation by helping others without demanding payment for service. Here, the aim is encourage virtual community members to build a sustainable community hallmarked by civic pride.

Each alliance member (online e-franchisee) of the virtual community, as described in detail above, may have a portal to their particular domain through the virtual community itself. In particular, links may be created to secondary websites from the centralized website for the virtual community (e.g., a website for the centralized HPO entity), such that an accessing user is familiar and comfortable with the secondary websites. This familiarity and comfort with the virtual community (e.g., a particular web domain) may generally be associated with a level of trust in the corresponding alliance members. Specifically, in accordance with the invention described herein, each secondary website for a particular e-franchise (alliance member) is built within the visual format of the virtual community's “look and feel,” such as a registered trademark of the HPO entity. For instance, websites for alliance members (online e-franchisees) regarding chess, bird watching, poetry, model railroading, screenwriting, rugby, wine, bicycles, motorcycles, gardening, and so on, all look and feel the same. In other words, as described above, while the subject and content of each website is different (i.e., the particular field of endeavor), all the websites look and feel is the same. For example, this is much like conventional e-franchises, such as well-known fast-food restaurants, only in a novel online community manner as detailed herein according to the present invention, where the online “menu” available is essentially limitless.

The illustrative centralized HPO entity therefore provides a portal for the virtual community's alliance members, as described herein, as well as other beneficial features for the community members. For instance, the HPO entity may provide the technology necessary to create the business operations and quality controls needed for separate but seamless operation conducting e-commerce in the disparate regions of the world. For example, such technology may support multiple languages (e.g., English, French, German, Russian, Spanish, Arabic, and Chinese, each of the seven languages of the UN). While current technology generally does not guarantee perfect translation from one language to another, computerized translation may be used, or separate centralized websites (or regions of a centralized website) may be maintained for each supported language to ensure proper language usage (i.e., non-translated websites). In other words, in addition to supplying practical operational capabilities for e-commerce, and interactive social networks (e.g., conferencing, gaming, etc.), the centralized entity may be configured to provide distributive management operations based on geographic and/or political territories.

In addition, the illustrative centralized entity may manage implications of currency exchange, tax liabilities, etc., such as through providing the centralized bank. For instance, it may be required that all alliance members transact business using the centralized bank (e.g., managed/maintained by the centralized HPO entity). Using such centralized accounting for the virtual community provides various benefits, such as, inter alia: i) instantaneous online access by alliance members to account status, profit/loss figures, tax liability, tracking transactions from start to end of the supply chain, etc.; ii) efficiencies in the cost of doing business by eliminating the need for accounting by each individual member; iii) centralized up-to-the-moment currency exchange as practiced by banks with credit card operations recognized worldwide; and iv) taxpayer compliance, such as by providing individual alliance members with tax filing forms and/or service.

Other services may be provided by the centralized entity (or centralized website), such as contracting (e.g., providing contract templates), where all transactions through the virtual community may be required to be executed using the supplied contracts. The purpose of this contracting practice is to ensure transparency and fair trade, such that all business entities (secondary entities) are held to the same approved business practice (e.g., disclosures, warranties, and other contractual obligations). Linked with the centralized banking, the unique business community provides reasonable techniques for reducing risk of criminal activity, extortion, and corruption.

Standards set forth by the centralized HPO entity may be applied to the alliance members, in addition to those standards/policies as described above. For example, the centralized HPO entity (e.g., administrators, a centralized management group, etc.) may monitor the data and content of the individual alliance members' secondary websites for illegal or unacceptable use and may limit the activity (e.g., restrict/limit access, deny membership in the virtual community, etc.), or may otherwise report the activity (e.g., sanctions, warnings, etc.). In particular, the illustrative HPO entity employs the necessary human rights protections and information security policies and practices to vigorously pursue any exploitation as well as the intentional and unintentional use of data from second or third parties. Unintentional use includes distributing intellectual property or data to the public-at-large, where it might be used to undermine the centralized entity or the interests of any secondary entity/member. (Note that all data collected and stored by the illustrative centralized entity may be safeguarded and protected by intellectual property rights, such as financial statements, individual demographics, records of individual transactions, etc.)

Furthermore, the illustrative virtual community may contain and inherently depend upon a certification process (or a facsimile thereof) for fair trade and transparency for each product and service offered by its alliance members. In the virtual community marketplace, the aim is not simply to state principles of fair trade and transparency but to actually provide proof of meeting the principles by providing the consumer with “value added” information consistent with fair trade practices accepted worldwide. For example, sellers within the community must be prepared to answer with a reasonable reply: “exactly what are the ingredients? Where did this come from? How was this grown? Who harvested the crop? Who manufactured the goods? What is the package made of? How was it transported?” and so on. These answers may be in response to questions posed by the centralized entity personally as a quality control measure, or may be necessarily included within the associated secondary website of the alliance members.

Through the violation of the principles set forth by the centralized HPO entity, an alliance member may lose the right to belong to the virtual community. The determination of when the principles have been violated to this degree may be made by the HPO entity, dynamically (e.g., by a website policy engine), or by a certain number of other alliance members. For example, a business entity that purchases a membership by using a false identity may be forced to forfeit all community ownership and assets. This provision intends to protect the community from outside meddling, and from unfriendly business practices from competing entities. Other examples for principle violation may simply be failing to pay community fees (e.g., the repayment of a microeconomic loan), posting illegal content, distributing a faultily advertised product, etc.

Notably, the business and social transactions conducted by members of the virtual community may be based on civil society principles and practices identified herein. (For example, members may generally “obey the unenforceable” obligation to beneficence—giving to others who for no fault of their own are in need, where charitable contributions are accounted for as part of tax obligations, but the purposes and amounts of gifts need not be made public.) However, since no society can expect all members to have equal interest or capacity in meeting these expectations (e.g. fair trade and transparency), all members of the community are expected to be prudent in conducting business, choosing associates, and in building social networks. Moreover, members should secure necessary protections as in contracted services and products to reduce risk of violations. In so doing, the illustrative virtual community, particularly the overseeing centralized HPO entity, may improve its ability to identify those seeking to conduct illegal, unfair, or socially irresponsible transactions, whether the transactions are business related or social in nature.

Further, since the e-franchise-like e-commerce alliances may have equal and commercially unrestricted access to all markets, territories, and cohorts of interest, it is important to note that such access may be subject to the lawful actions of political entities, and that there may exist de facto limitations such as natural monopolies where a service or product is unique to cultural or environmental circumstances. This may be considered to be in contrast to other business agreements where, for example, a sales person has exclusive rights to a geographic territory or line of products or services. The illustrative HPO entity is generally opposed to the manipulation of its unique combination of fair-trade and transparency principles and practices that would result in the perpetuation or increase in socioeconomic disparities, and thus various policies and/or standards may be put in place to safeguard against such occurrences.

In accordance with the illustrative embodiment described herein, the centralized HPO entity may generate and distribute income and wealth using the following discrete and interdependent business practices:
i) Membership in a particular virtual community may be limited;
ii) Each alliance (secondary entity) may pay membership fees and fees for services (e.g., where each alliance/member pays the same);
iii) Each alliance (secondary entity) may own common stock in the centralized HPO entity as part of membership, and in certain embodiments, only members of the particular virtual community can own the common stock;
iv) A proportion of profit (net) yielded by an alliance may be kept by the centralized HPO entity and used to increase the value of the common stock; and
v) Financial accounting may be centralized and transparent, where all members use the centralized bank exclusively (which provides all accounting needed for operations)—thus, earning any transaction fees and interest gained on capital.

(Note that according to an illustrative embodiment, preferred stock may represent the proportionate investment of the HPO entity, and is not transferable except by consensus or to other partners by insurance or other means, and the voting rights of the owners are managerial. Common stock ownership, on the other hand, is achieved by issuance of “shares” to alliance members, e.g., in a conventional manner. Limiting shares to members (e.g., less than half of the shares) ensures that the centralized entity cannot be bought or sold by a third-party. Voting rights for common stock owners may be consultative only.)

As described above, certain secondary entities (alliance members) may not begin their entrepreneurial online e-franchise with enough capital to join the virtual community. As such, a supply of microeconomic capital may be available, such as bank secured funds loaned to individuals to build an “interest,” thus providing the ability to link not-for-profit entities with a business structure and operations separate from the for-profit corporations (i.e., the alliance members). According to one or more embodiments herein, such microeconomic loans may be contingent upon mentoring and meeting certain educational and/or business education criteria. For instance, mentoring for novice entrepreneurs may be provided by a consortium of voluntary civic organizations (e.g., Rotary International, YMCA International, and others). The majority of the mentoring may be accomplished via telecommunications, such as live web-based instruction delivered by selected and supervised volunteer business mentors. In this manner, someone without the capital will be afforded both the capital and an accompanying (and illustratively mandatory) education in managing that capital in terms of building a successful business entity.

### ONLINE E-FRANCHISE/ALLIANCE BUSINESS EXAMPLES

The advantageous technology and techniques described herein may be used by any illustrative centralized entity (e.g., the HPO entity) and any illustrative secondary entities (e.g., e-franchisees/alliance members) in any desired capacity. For instance, the HPO entity may desire to use social business networking to link volunteers with aspiring entrepreneurs. The volunteers may serve as mentors, and may also provide seed funding consistent with the contractual agreements approved by and provided by the HPO entity. These volunteers may thus serve a needed public service when it comes to helping the poor to secure financing (e.g., through the centralized bank), and to subsequently conduct e-commerce business.

Businesses may comprise any field of endeavor from hobbies, products, travel, information, education, activities, etc. Contractual relationships between a visitor to the community and the corresponding alliance member (that is, when a user accesses a particular secondary website) need not have any explicit obligations other than what is offered by that particular alliance member's website. For example, a user may have a desire to learn French, and indicates this on a centralized chat facility of the community (e.g., within an education chat room, or a chat room about France, etc.). An alliance member may thus be able to contact the interested user and say something as simple as, “I teach French, where shall we start?” Conversely, the interested user may be offered one or more French teaching secondary websites, which may offer software, tapes, personal instruction, etc., depending upon the various secondary websites available (e.g., one site dedicated to all things related to teaching French, or a plurality of France-related sites, etc.). An online e-franchise devoted to teaching French is not obligated to teach anything else (e.g., other languages, French history, etc.), and a student and mentor might spend hours a day over weeks and months and years in a learning relationship, with no formally defined education curriculum; just a desire to learn (and teach) French.

The following illustrations demonstrate example business opportunities that may advantageously utilize the teachings of the present invention described herein. The possibilities are essentially endless, and the examples below are merely a finite representation of simplified examples, meant to offer the reader a starting point in understanding the vast expanse of business opportunities available to alliance members of the virtual community embodied in accordance with the invention. From selling surfboards in California, to hand-woven baskets from Mumbai, to bird watching groups in Australia, to selling car parts in Peru, any conceivable business model may benefit from membership in the virtual community. In this manner, each alliance member (online e-franchisee) may be afforded with the tools necessary to create and maintain a profitable online business, where the client's trust and familiarity in the virtual community as a whole generates previously unavailable revenue streams. That is, the basket-weaver in Mumbai may not have been able to attract clients to a poorly run/funded website, and those clients may not have trusted the source of the website (scams, product quality, etc.). However, through the virtual community and the technology of the present invention described herein, those obstacles may be substantially overcome, broadening the horizon of efficient and effective business operation across the globe. (Notably, though not all businesses need to be profitable, with fees and costs associated with membership, it is anticipated that most will at least attempt to be profitable.)

### Business Opportunity Example #1

Assume that someone has a passion for playing chess (it can be almost any “interest” people have, e.g., outside of work). This someone can obtain online e-franchise rights from a centralized entity to “own” rights to a secondary website regarding chess on the virtual community (that is, through the centralized website), for example, in one of the supported languages and/or in one particular geographic region. The cost of owning and retaining the rights to the online e-franchise (or domain) for “Chess in country X” at the virtual community may be set by the centralized entity (corporation) and corresponding marketplace, such as based on chess interest, the particular country, or a flat fee for any rights. By purchasing the rights, the new alliance member (online e-franchisee) may also have the right to purchase stock options in the parent corporation (centralized entity), thereby enabling revenue from commission on business created by the online e-franchise/enterprise, and also by owning shares of the centralized entity.

Assume further that a user (“client”) goes to the centralized website, that he/she is familiar with and trusts, and “clicks” on a CHESS link. The client is then illustratively redirected to a Chess-related site, having a choice of language (e.g., English, Arabic, Chinese, French, German, Russian and Spanish) and a choice of country to which the client wishes to focus his/her search or activity (e.g., any of the 192 member states of the United Nations), a particular combination of selections redirecting the client to the illustrative alliance member's secondary website. Alternatively, the initial centralized website may first request the language and/or country, and available topics/secondary websites may be presented (e.g., the alliance member's site for Chess in the particular language and country, in addition to any other secondary websites, for example, organized by any variety of means for user-friendliness).

After selecting the secondary website, the centralized servers transmit the secondary website to the client's computer to display the content (managed by the illustrative alliance member/secondary entity), which has the same look and feel that the client is accustomed to from the virtual community's centralized website, as described above.

As an example layout of the secondary website (which may conform to a particular shared template that may be used by any other secondary website on the virtual community) may appear (textually) as follows:

I) Chess: Happening Now and in the Near Future
A) Chess Tournaments Live and Scheduled
B) Chess Clubs and Organizations
C) Want to Play?
   i) Virtual chess (multiple games)
   ii) Play chess live online
   iii) Travel to country of choice and play:
      a) With a newly found opponent or
      b) In a Local tournament

II) E-Commerce
A) Book a vacation to the selected geographic region:
   i) Airlines, Trains, cruise ship
   ii) Hotel
   iii) Bed and Breakfast
   iv) Hostel
   v) A Local Host $00.00
   vi) Rent A Car
   vii) Etc.
B) Chess sets, timers, and furniture
   i) Amateur
   ii) Professional
   iii) Swap (online auctions)
C) Films
D) Books
E) Tutors
F) Etc.

III) Archives
A) Great Books on Chess
B) Greatest Chess Matches
   i) matches played by Bobby Fisher
   ii) other Grandmasters of chess
C) Etc.

IV) Blogs and Diaries
A) “I have been thinking about chess . . . ”
B) “My husband plays chess, and I don't get why?
C) “I want my grandchildren to know what it was like when I played in a chess tournament at age 5 . . . .”

V) Live Conferencing
A) “I was thinking about a chess set. How much did you pay for the wooden pieces over there on your chessboard?”

In the above layout, each option may be another hyperlink (“link”), frame, window, etc., and the purpose of the illustration is merely to demonstrate information and business that may be available to someone looking at a secondary website about chess. The template may be defined by the centralized entity, and not all information need be included. For example, assume another secondary entity is selling surfboards on a secondary website. This website may have surfing events, e-commerce (selling boards), and blogs, but may not offer archives or live conferencing. The surfboard website may additionally have non-templated links to related sites, such as external links to surf-related products (if allowed by the virtual community to do so), or links to other surf-related secondary websites of the virtual community (e.g., surfing in other countries).

### Business Opportunity Example #2

HPO travel has value added capabilities in the ways it can link people locally and globally (e.g., “meet and make travel”). For example, through the combination of offered secondary websites, a client can travel to a far-off location to meet a person who actually made a “thing,” and then take lessons from the maker on how to make that “thing,” returning home with a “thing” made by the traveler. The HPO social networking may also result in local travel to meet a person making a “thing.” For instance, in the example #1 above, a user/client may find a secondary website for chess in France, and may find links to travelling to France and learning to speak French on that website. Through the collaboration of the virtual community, the user may learn from a French instructor before travelling, travel to France, meet the person with whom the client played online chess through the website, and visit a fantastic bistro in Paris recommended by a blogger on the French chess secondary website. Alternatively, in another example above, a client/user may book travel to meet with the alliance member in Mumbai that is making saris to learn (or at least witness) the fine art from the source, who is a trusted member of (is responsible to) the virtual community.

In addition, virtual HPO travel may be accomplished by using sophisticated state-of-the-art two-way communication. That is, instead of actually traveling to “meet and make,” virtual HPO travel may connect stay-at-home travelers with far away “makers” (such that HPO “travel” overlaps with HPO “learning”). Through teleconferencing, video blogs, etc., a person in the United States could meet and/or watch the Mumbai alliance member making the saris or baskets, etc., and need not ever leave the comfort of his/her own surroundings. Accordingly, the virtual community both connects people globally on a physical level, as well as on a virtual level.

Note that one additional facet of HPO travel may illustratively comprise HPO vacations (such as “Connections for Civic Action”). The purpose of these HPO vacations may be to join a local group devoted to advancing society (e.g., the goals of the United Nations) and similar civil society organizations. For example, through this particular secondary website, users/clients (e.g., college students) may book an alternative Spring Break, such as for various organizations, like UNESCO, UNICEF, and Habitat for Humanity.

### Business Opportunity Example #3

As a third example “business opportunity,” a location within the virtual community (within the centralized website, e.g., its own domain or a collection of secondary websites) may be dedicated to expanding innovations across the global economy. For instance, the HPO entity may offer a place where innovation may be fostered through, among other things, Best Practices Replication, Request for Proposals, Problem Solving, Inventions, Creative Enterprise, and Prizes for Targeted Commonwealth Achievements. This portion of the virtual community is specifically intended to serve as a means for focusing attention on problems, replicating/distributing best practices and generating solutions to targeted problems identified by members of the virtual community, expanding HPO from various parts of the world to those in need.

For example, as a civic forum, and competitive business enterprise, people have a place to explain and “post” their own request for proposals (RFPs). If a person wants to form a group to build a better “X” (e.g., low power water wells), groups can be formed of people from anywhere on earth, where ever-expanding technologies allow for collaboration possibilities that are literally without end. The virtual community (centralized website) may thus contain a “library” for entrepreneurs, including a place for governments to post RFPs (e.g., establishing no closed bidding and a fair field for all who want to compete for state contracts anywhere in the world). In addition, this library may be comprised of available libraries, digital archives, and scholarly collections worldwide (for innovations, or simply education, abiding by local and international copyright laws).

Illustratively, an idea, initiative, or invention can also accept funding from individuals. Accordingly, if a person finds a group working on a problem of interest, and if the group is looking for funds, the interested party can “invest” in the group, for example, with the understanding that they may be an owner/shareholder if the group makes any profit. By going through the virtual community, the HPO entity can (reasonably) assure that all transactions/business is transparent, all trade is fair, and the centralized bank does all the financial accounting/disbursement. As such, the investors may trust that the group is legitimate, functional, and accountable.

Furthermore, best practices replication illustratively includes actively seeding and/or distributing cutting edge research and development to solve important problems. For example, 1.3 billion people lack access to clean drinking water. There may be a cash prize for the best solution or “invention” to solve this problem. An RFP cash prize for clean water could come from the HPO entity itself (as an investor), but also from cash invested by individuals who believe in the inventors and have “bought stock” in their work. A second example is of an e-franchise for plastic injection molding where best practices are distributed to locations worldwide. Here the cost of goods and labor are put into context, e.g., encompassing the HPO entity's principles and rules. For instance, a new plastic manufacturing plant in China may be a start-up business owned and operated by local citizens, making products to be sold in that locale. By distributing the know-how of best practices to this new plant, the carbon footprint may be reduced by not having to transport goods to far away markets, and local business is nurtured thereby advancing civil society. This paradigm of doing business is in contrast to large multinational companies building large manufacturing plants in lesser-developed countries where workers are recruited from rural areas to manufacturing centers. The social consequences of which are known to be destructive to family life, further weakened the infrastructures of rural communities, and have proven to leave unwanted and excessive environmental problems. (Note that the purpose is not to just modify existing products and services, but to identify a need or problem and brainstorm ways to develop new ways of doing things and bring them to market.)

### III. Conclusion

As stated above, the present invention as described herein is directed to the computer architecture and functionality that may be used to establish these example e-commerce business models. In particular, a centralized website may be generated, stored, and executed on one or more servers within the architecture, where the centralized website has a particular “look and feel” (e.g., a template). In association with the granting of online e-franchise rights to a secondary entity, a secondary website may then be generated, stored, and executed (e.g., on the servers) for the secondary entity and its particular field of endeavor, where the secondary website has the same particular look and feel as the centralized website. Stored content for the secondary website may be managed and monitored to ensure that it (in addition to the business practice of the secondary entity) is being operated in accordance with standards set forth by the centralized entity.

Advantageously, then, the novel techniques described herein provide novel hardware and software arrangements for use with e-commerce enterprises having online e-franchises. By arranging and utilizing the hardware and software as described above, e.g., servers, centralized websites, secondary websites, templates, etc., the novel techniques allow the creation of a new kind of e-commerce model, e.g., a virtual community (for example, but not limited to, the HPO community above). In particular, the techniques described herein provide entities/sellers with the opportunity to engage in e-commerce where they can receive a platform for offering their products and services, while at the same time providing consumers with confidence that the entity that they are buying a product/service from is legitimate and reliable.

In addition, through the novel hierarchical website/entity arrangement, a small business may be associated and linked with a big-business, establishing a higher probability that the small business would prosper due to the firm backup and support of an established big business. Similar to conventional e-franchises, running a small business under the franchisor's name and organization is very beneficial for businesses that can't afford much finance and capital investment for their own business. However, unlike conventional franchises, the online e-franchises described herein allow a business entity to establish a business in any field of interest/endeavor, since the online e-franchise rights are associated with belonging to the virtual community of the overarching e-franchise (centralized entity), and not merely to having a same physical franchise in a different geographical location.

While there have been shown and described illustrative embodiments for providing hardware and software for the novel e-commerce system as described herein, it is to be understood that various other adaptations and modifications may be made within the spirit and scope of the present invention. For example, the embodiments have been shown and described herein with relation to certain protocols, communications, server distributions, etc. However, the embodiments of the invention in their broader sense are not so limited, and may, in fact, be used with any suitable protocols, e.g., website languages, communication techniques, and/or server arrangements, and the description above merely demonstrates one or more illustrative embodiments, as may be appreciated by those skilled in the art. In particular, while an example e-commerce model has been shown and described, other models may advantageously make use of the technologies described herein to supply and manage online e-franchise rights, in addition to the virtual community alliance illustratively described above.

The foregoing description has been directed to specific embodiments of this invention. It will be apparent, however, that other variations and modifications may be made to the described embodiments, with the attainment of some or all of their advantages. For instance, it is expressly contemplated that certain components and/or elements described herein can be implemented as software being stored on a tangible computer-readable medium (e.g., disks/CDs/etc.) having program instructions executing on a computer, hardware, firmware, or a combination thereof. Accordingly this description is to be taken only by way of example and not to otherwise limit the scope of the invention. Therefore, it is the object of the appended claims to cover all such variations and modifications as come within the true spirit and scope of the invention.

1. A method, comprising:
generating, storing, and executing a centralized website on a server maintained by a centralized entity, the centralized website having a particular look and feel;
granting, by the centralized entity to a secondary entity, online e-franchise rights for a particular field of endeavor within the centralized website, wherein the online e-franchise rights grant the secondary entity rights to operate within the particular field of endeavor for the centralized website;
generating, storing, and executing, by the centralized entity on the server, a secondary website for the secondary entity, wherein the secondary website is for the particular field of endeavor and has the same particular look and feel as the centralized website;
managing content stored on the server for the secondary website by the secondary entity for the particular field of endeavor; and
ensuring that the secondary website is operated in accordance with standards set forth by the centralized entity.

2. The method of claim 1, wherein the online e-franchise rights granted to the secondary entity are sole rights.

3. The method of claim 1, further comprising:
utilizing an online banking facility for transactions occurring through the secondary website.

4. The method of claim 3, further comprising:
transferring a payment from a user of the secondary website to the secondary entity through the online banking facility.

5. The method of claim 3, further comprising:
operating the online banking facility by the centralized entity.

6. The method of claim 1, further comprising:
accessing the secondary website through the centralized website.

7. The method of claim 1, wherein the secondary website is within an online domain of the centralized website.

8. The method of claim 1, wherein granting further comprises:
granting, to the secondary entity, the rights for the particular field of endeavor for a particular geographical region within the centralized website.

9. The method of claim 8, wherein the geographical region is one of a country, a global location, a state, a region, or a continent.

10. The method of claim 1, wherein ensuring further comprises:
eliminating the online e-franchise rights for the secondary entity in response to determining that the secondary website is not operated in accordance with the standards set forth by the centralized entity.

11. The method of claim 1, wherein granting comprises:
transferring shares of stock associated with the secondary website to the centralized entity in exchange for the online e-franchise rights.

12. The method of claim 1, wherein the secondary entity starts a business in the field of endeavor in response to the centralized entity granting the secondary entity the online e-franchise rights.

13. The method of claim 1, wherein the particular look and feel comprises one or more particular colors, logos, fonts, layouts, trademarks, and service marks.

14. The method of claim 13, wherein the particular look and feel is based on a web template that utilizes the one or more particular colors, logos, fonts, layouts, trademarks, and service marks.

15. The method of claim 1, wherein the standards set forth by the centralized website comprise principles related to fair trade practices.

16. The method of claim 1, further comprising:
limiting the granting of online e-franchise rights to secondary entities located in a country belonging to the United Nations.

17. The method of claim 1, wherein granting further comprises:
granting, by the centralized entity, the online e-franchise rights in exchange for money.

18. The method of claim 17, further comprising:
providing, by a third entity, the secondary entity with financing needed to obtain the online e-franchise rights through a contractual agreement between the secondary entity and third entity.

19. The method of claim 18, further comprising:
approving, by the centralized entity, the contractual agreement before the third entity provides the secondary entity with the financing.

20. The method of claim 18, wherein the third entity is the centralized entity.

21. The method of claim 1, further comprising:
providing, by the centralized entity, the secondary entity with equipment and training to manage and operate the secondary website.

22. The method of claim 1, further comprising:
supporting text of the centralized website and text of the secondary website in a plurality of languages.

23. The method of claim 22, wherein the plurality of languages are languages supported by the United Nations.

24. The method of claim 22, further comprising:
selecting, by a consumer entity, a preferred language from the supported languages for accessing the centralized website.

25. The method of claim 22, further comprising:
selecting a specific field of endeavor by the consumer entity based on available fields of endeavor having secondary websites supporting the preferred language.

26. The method of claim 1, further comprising:
allowing the secondary entity to obtain stock in the centralized entity.

27. The method of claim 1, further comprising:
generating, storing, and executing, by the centralized entity, a third website for a third entity for a different field of endeavor than the particular field of endeavor, wherein the third website and the secondary website have the same look and feel.

28. The method of claim 1, further comprising:
storing the centralized website and secondary website on a same server.

29. The method of claim 1, further comprising:
distributing the one or more servers globally.

30. The method of claim 29, further comprising:
assigning a particular server of the one or more servers for storing the secondary website based on a global location of the corresponding secondary entity.

31. An apparatus, comprising:
one or more network interfaces configured to communicate with a computer network;
a processor coupled to the one or more network interfaces and configured to execute one or more processes; and
a memory configured to store executable code for websites, a web template for the websites having a particular look and feel, a set of dynamically enforceable standards set forth by a centralized entity, and centralized server process executable by the processor, the centralized server process when executed operable to:
maintain a centralized website created by the centralized entity, the centralized website having the particular look and feel;
maintain a secondary website having the same particular look and feel as the centralized website based on the template for a secondary entity, the secondary website operated for the particular field of endeavor for which the secondary entity has obtained online e-franchise rights within the centralized website;
grant access to the secondary entity to manage content of the secondary website based on authority granted by the centralized entity; and
dynamically ensure that the secondary website is operated in accordance with the standards set forth by the centralized entity.

32. The apparatus of claim 31, wherein the memory is further configured to store an online banking process, the online banking process when executed by the processor operable to handle financial transactions occurring at the secondary website and through the computer network.

33. The apparatus of claim 32, wherein the online banking process when executed by the processor further operable to transfer at least a portion of a payment from a user to the secondary entity in response to a financial transaction occurring at the secondary website.

34. The apparatus of claim 31, wherein the centralized website contains code such that the secondary website is accessible through the centralized website.

35. The apparatus of claim 31, wherein the secondary website is accessible from within an online domain of the centralized website.

36. The apparatus of claim 31, wherein the centralized server process when executed is further operable to eliminate the online e-franchise rights granted to the secondary entity in response to the secondary website not meeting the standards set forth by the centralized entity.

37. The apparatus of claim 31, wherein the particular look and feel comprises one or more particular colors, logos, fonts, layouts, trademarks, and service marks.

38. The apparatus of claim 37, wherein the particular look and feel is based on a web template that utilizes the one or more particular colors, logos, fonts, layouts, trademarks, and service marks.

39. The apparatus of claim 31, wherein the standards set forth by the centralized website comprise principles related to fair trade practices.

40. The apparatus of claim 31, wherein the centralized server process when executed is further operable to provide access to a user to the centralized and secondary websites.

41. The apparatus of claim 31, wherein the centralized server process when executed is further operable to support text of the centralized website and text of the secondary website in a plurality of languages.

42. The apparatus of claim 41, wherein the plurality of languages are languages supported by the United Nations.

43. The apparatus of claim 41, wherein the centralized server process when executed is further operable to:
provide access to a user to the centralized and secondary websites; and
determine a preferred language selected by the user.

44. The apparatus of claim 43, wherein the centralized server process when executed is further operable to provide the user with options from which to choose a specific field of endeavor in response to the selected preferred language.

45. The apparatus of claim 31, wherein the centralized server process when executed is further operable to store and execute a third website for a third entity for a different field of endeavor than the particular filed of endeavor, wherein the third website and the secondary website have the same look and feel.

46. A method, comprising:
generating a centralized website on one or more centralized servers, the centralized website maintained by a centralized entity and having a particular look and feel;
traveling, by a representative of the centralized entity, to a geographical area to determine whether a secondary entity is interested in obtaining online e-franchise rights for a particular field of endeavor within the centralized website;
in response to determining that the secondary entity is interested in obtaining online e-franchise rights for the particular field of endeavor within the centralized website, granting the online e-franchise rights to the secondary entity;
establishing, by the centralized entity, a secondary website on the one or more centralized servers, wherein the secondary website has the same look and feel as the centralized website;
providing, by the representative, the secondary entity with equipment to operate and manage the secondary website from the geographical area;
configuring, by the secondary entity, the secondary website to include content related to the particular field of endeavor that does not violate principles established by the centralized entity; and
managing, by the secondary entity, the content on the secondary website.

47. The method of claim 46, further comprising:
managing, by the secondary entity, the content on the secondary website while the secondary entity is located in the geographical area.

48. The method of claim 46, further comprising:
utilizing an online banking facility for transactions occurring through the secondary website.

49. The method of claim 48, further comprising:
transferring a payment from a user of the secondary website to the secondary entity through the online banking facility.

50. The method of claim 48, further comprising:
operating the online banking facility by the centralized entity.

51. The method of claim 46, further comprising:
providing, by the representative, the secondary entity with the training to operate and manage the secondary website from the geographical area.

52. The method of claim 46, wherein granting further comprises:
granting, to the secondary entity, sole online e-franchise rights for the particular field of endeavor for the geographical area within the centralized website.

53. The method of claim 52, wherein the geographical region is one of a country, a global location, a state, a region, or a continent.

54. The method of claim 46, further comprising:
eliminating the online e-franchise rights for the second entity in response to determining that the secondary website is not operated in accordance with the principles set forth by the centralized entity.

55. The method of claim 46, wherein the particular look and feel comprises one or more particular colors, logos, fonts, layouts, trademarks, and service marks.

56. The method of claim 55, wherein the particular look and feel is based on a web template that utilizes the one or more particular colors, logos, fonts, layouts, trademarks, and service marks.

57. The method of claim 46, further comprising:
limiting the granting of online e-franchise rights to secondary entities located in a country belonging to the United Nations.

58. A method, comprising:
generating a centralized website on one or more centralized servers, the centralized website maintained by a centralized entity and having a particular look and feel;
granting, by a centralized entity, online franchising rights to a secondary entity residing in a geographical area, wherein the online e-franchise rights grant the secondary entity rights to offer information and services related to travel to the geographical area;
generating, storing, and executing, by the centralized entity, a secondary website for the secondary entity, wherein the secondary website has the same look and feel as the centralized website and is accessed by users interested in traveling to the geographical area;
managing content of the secondary website by the secondary entity related to travel to the geographical area; and
ensuring that the secondary website is operated in accordance with standards set forth by the centralized entity.

59. The method of claim 58, wherein the online e-franchise rights granted to the secondary entity are sole rights.

60. The method of claim 58, further comprising:
providing access to the centralized website for a particular user interested in a specific geographical location;
determining a particular geographical area from the centralized website selected by the particular user; and
directing the particular user to a particular secondary website having content related to travel to the geographical area.

61. The method of claim 58, further comprising:
accessing the centralized website by a particular user interested in a specific geographical location;
selecting, by the particular user, a specific geographical area from the centralized website, wherein the selecting directs the particular user to a specific secondary website managed by a corresponding secondary entity; and
obtaining, by the particular user, information related to travel to the specific geographical area from the secondary website.

62. The method of claim 58, further comprising:
managing content of the secondary website by the secondary entity related to leisure in the geographical area.
